(19) United States
(12) Patent Application Publication
(10) Pub. No.: US 2008/0301924 A1
(43) Pub. Date: Dec. 11, 2008

(54) Combined tamping tool and packing follower

(76) Inventor: Jeff Jarrett, Pratville, AL (US)

Correspondence Address: James G. O'Boyle, Esq.;711 Chevy Chase Building, 5530 Wisconsin Avenue, Chevy Chase, MD, 20815, US

(21) Appl. No.: 11/806,851

(22) Filed: Jun. 5, 2007

(51) Int. Cl. B23P 19/02

(52) U.S. Cl. 29/235

(57) ABSTRACT

A combined tamping tool and packing follower, wherein a cylindrical sleeve having a threaded outer surface is threaded through a packing gland for compressing a packing set, wherein each seal ring of the packing set is sequentially pressed into a stuffing box using the sleeve to seat each ring, whereupon the sleeve is fixed to function as a packing follower. The sleeve includes a nose portion for pressing the rings into the stuffing box, an interior seal, drain holes, and wrench engaging apertures.

### BACKGROUND OF THE INVENTION

When installing packing rings in a stuffing box of a pump, agitator, mixer, valve and the like, a tamping tool is employed to individually tamp or seat each packing ring in the stuffing box.

Many maintenance mechanics do not carry a proper tamping tool; accordingly, the existing packing follower is employed to push the first packing ring as far as it can into the stuffing box but never far enough to push the first ring all the way to the bottom of the stuffing box. Subsequent rings are similarly installed to provide a five or six ring set of packing. The innermost packing rings seal the process medium; therefore, if these rings are not correctly installed, they will not properly compress under the mechanical bolt load provided by the packing follower when the five ring set is installed resulting in the migration of process medium into the bottom of the stuffing box, thereby reducing the life of the packing set and ultimately the equipment itself.

### SUMMARY OF THE INVENTION

After considerable research and experimentation, the combined tamping tool and packing follower of the present invention has been devised to provide not only a tool to properly seat each ring of a packing set in a stuffing box, but also to function as a packing follower compression loading device to compress the packing set in the installed position in the stuffing box.

The combined tamping tool and packing follower of the present invention comprises, essentially, a sleeve having a threaded outer surface adapted to be threadably mounted in a packing gland. One end of the sleeve is provided with a nose portion adapted to engage each packing ring during the installation of the packing set. The opposite end portion of the sleeve is provided with a plurality of circumferentially spaced apertures adapted to be engaged by a spanner wrench when the tool is being used for properly compressing a packing set. A plurality of circumferentially spaced drain holes extend radially through the sleeve side wall in proximity to the nose portion, and a radially inwardly extending seal is mounted on the interior surface of the sleeve in proximity to the drain holes.

### BRIEF DESCRIPTION OF THE DRAWINGS

FIG. 1 is a sectional side elevational view of a prior art packing follower employed for seating a packing set into a stuffing box of a pump;

FIG. 2 is an exploded perspective view of the combined tamping tool and packing follower of the present invention;

FIG. 3 is a side elevational view of the combined tamping tool and packing follower of the present invention;

FIG. 4 is an end elevational view of the tool shown in FIG. 3;

FIG. 5 is a sectional side elevational view of the tool taken along line 5-5 of FIG. 4;

FIG. 6 is an end elevational view of a packing gland employed with the tool of the present invention.

FIGS. 7, 8, 9 and 10 are sectional side elevational views illustrating the use of the tool of the present invention for sequentially installing each packing ring of a five ring set into a stuffing box.

### DESCRIPTION OF THE PREFERRED EMBODIMENTS

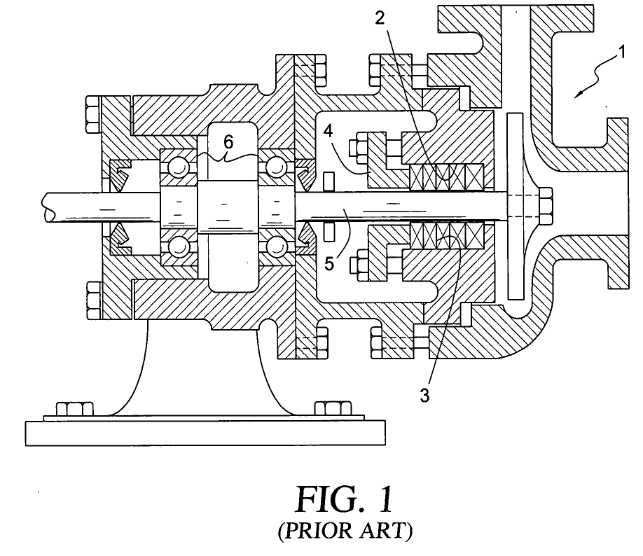

Referring to the drawings, and more particularly to FIG. 1, there is illustrated a conventional pump 1 having a stuffing box 2 containing a packing ring set 3 held in the stuffing box 2 by a conventional packing follower 4, to thereby prevent the migration of process medium from the pump into the stuffing box 2, and along the pump shaft 5 to the shaft bearings 6.

Heretofore, the conventional packing follower 4 has been employed for installing the packing set 2; however, to provide an adequate fluid tight seal, each sealing ring has to be properly installed in the stuffing box, beginning with the first sealing ring which has to be seated at the innermost end of the stuffing box. Obviously the end portion of the packing follower 4 which extends into the stuffing box 2 is not long enough to push the first sealing ring all the way to the bottom of the stuffing box. If the first sealing ring is not properly installed, then the subsequent sealing rings will also not be properly installed resulting in fluid flowing from the pump 1 along the pump shaft 5 to the bearings 6.

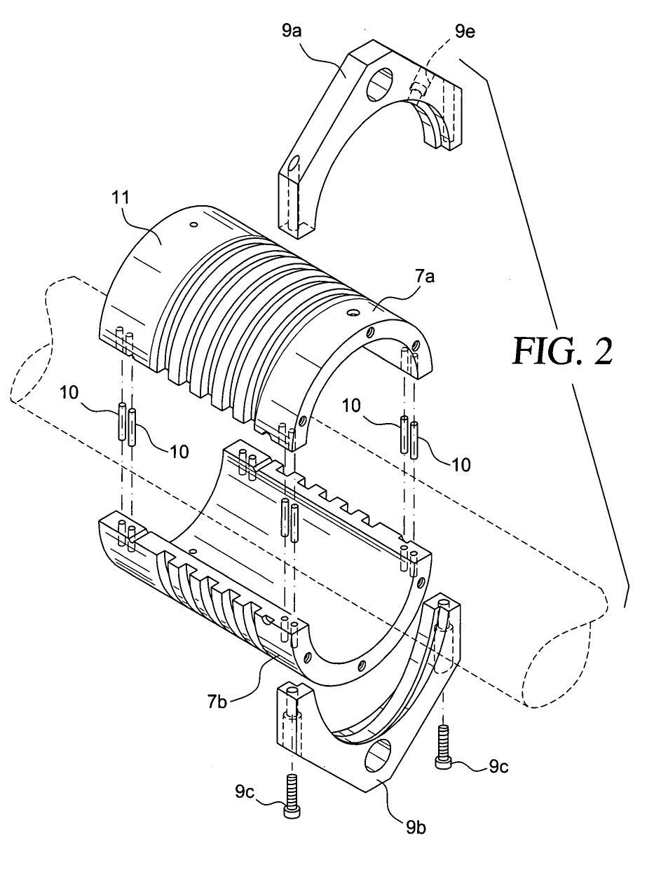

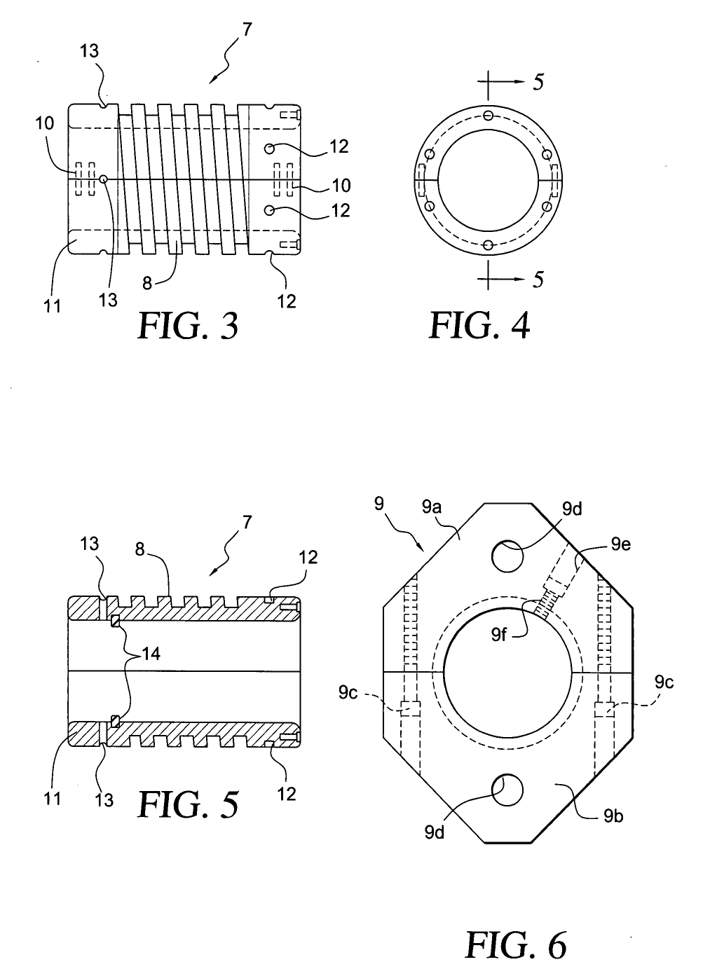

To obviate the problems experienced with conventional packing followers as shown in FIG. 1, the combined tamping tool and packing follower of the present invention has been devised, as shown in FIGS. 2, 3, 5 and 6, and comprises a sleeve 7 having a threaded outer surface 8 adapted to be threadably mounted in a packing gland 9. The sleeve 7 can be either continuous or split in half, as shown in FIG. 2, wherein the halves 7a, 7b are connected by dowels 10 to form a continuous sleeve 7, as shown in FIG. 3. A nose portion 11 is provided on one end of the sleeve adapted to engage each stuffing or sealing ring of a packing set, to be described more fully hereinafter. The opposite end portion of the sleeve is provided with a plurality of circumferentially spaced apertures 12 adapted to be engaged by a spanner wrench, not shown, when the tool is being used for compressing a packing set. A plurality of circumferentially spaced drain holes 13 extend radially through the sleeve side wall in proximity to the nose portion 11 and a radially inwardly extending seal 14 is mounted on the interior surface of the sleeve 7 in proximity to the drain holes 13.

The packing gland ring 9, as shown in FIGS. 2 and 6, can either be continuous or split to form halves 9a and 9b secured together by suitable bolts 9c. Through holes 9d are also provided in the gland ring through which the mounting bolts 9c are adapted to extend, and a radial bore 9e is provided for receiving a set screw 9f.

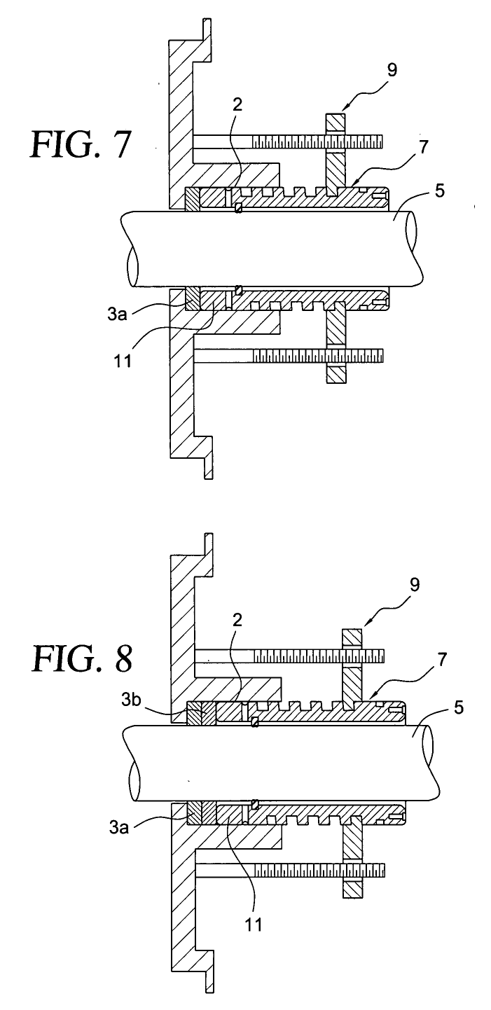

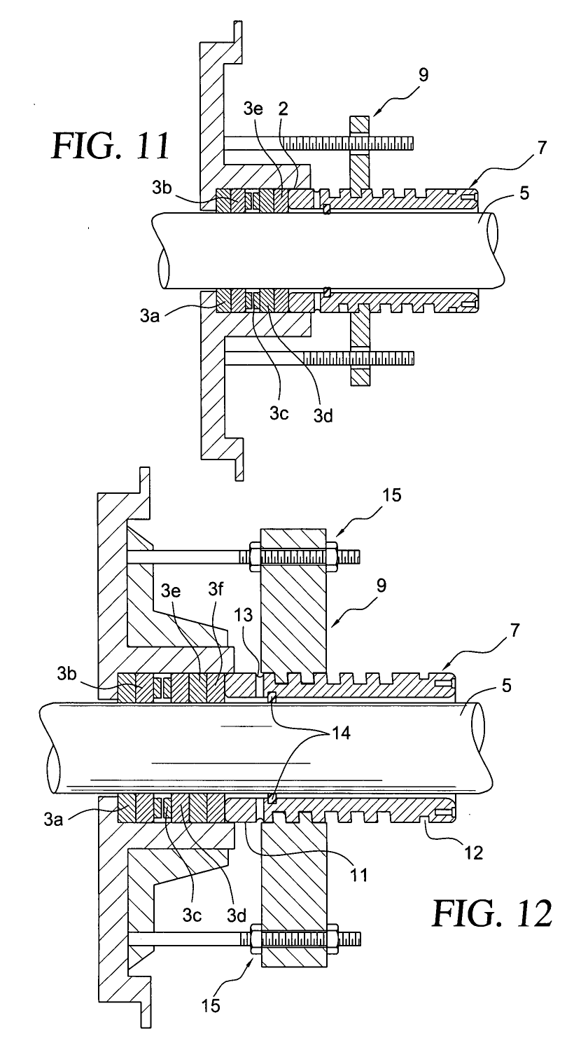

The installation of a typical five ring packing set is illustrated in FIGS. 5, 7 to 12, wherein a first sealing ring 3a is placed around the shaft 5 and seated at the end of the stuffing box 2 by means of the tool of the present invention, wherein sleeve 7 is manually pushed or tamped so that the nose portion 11 of the sleeve presses the ring 3a into the bottom of the stuffing box and in sealing engagement with the shaft 5.

The sleeve 7 is then pulled out of the stuffing box 2 and a second sealing ring 3b is placed around the shaft, as shown in FIG. 8, and the sleeve is once again manually pushed into the stuffing box to thereby compress sealing ring 3b against the first sealing ring 3a.

The packing gland 9 is then mounted on the equipment through which the sleeve 7 is threaded using a spanner wrench whereby the sleeve 7 is threaded into the stuffing box 5 to thereby put a compression pre-load on sealing rings 3a and 3b.

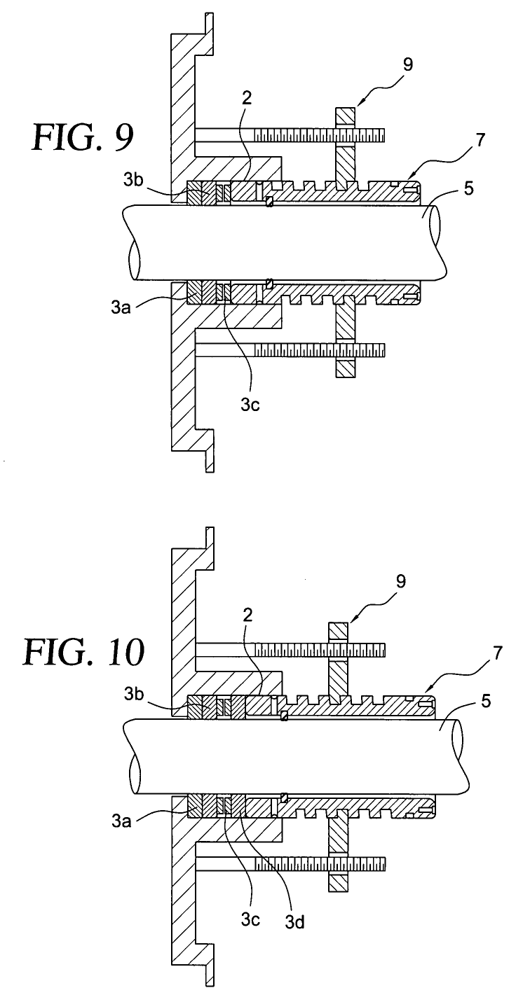

The installation steps are continued as shown in FIGS. 9 to 12 wherein subsequent sealing rings 3c, 3d, 3e and 3f are sequentially installed to provide the packing set 3, as shown in FIG. 12, whereupon the set screw 9f is threaded inwardly against the sleeve 7 and the packing gland is set by a double nut arrangement 15.

From the above description it will be appreciated by those skilled in the art that the combined tamping tool and packing follower of the present invention provides an improvement for installing sealing rings in a stuffing box, in that the device is used not only as a tamping tool for sequentially installing sealing rings in a stuffing box around a shaft, but also once the packing set is positioned in the stuffing box, it is employed as a packing follower for compressing the packing set in the installed position in the stuffing box.

Furthermore, greater packing set life can be expected in that each packing ring has been installed individually with some pre-compression load applied and the double nut and sleeve arrangement transfer the compression load from the pump stuffing box studs to the sleeve 7.

It is to be understood that the form of the invention herewith shown and described is to be taken as a preferred example of the same, and that various changes in the shape, size and arrangement of parts may be resorted to, without departing from, the spirit of the invention or scope of the subjoined claims.

I claim:

1. A combined tamping tool and packing follower for installing a packing set around a shaft in a stuffing box, comprising a cylindrical sleeve, a threaded portion on the exterior surface of said sleeve, a nose portion on one end of said sleeve for pressing ring seals into said stuffing box, and a packing gland, said sleeve being threadably mounted in said packing gland, whereby sealing rings are sequentially installed in said stuffing box around the shaft by threading the sleeve inwardly and outwardly of the stuffing box until the desired packing set is installed, whereupon the sleeve is mounted in fixed position to function as a packing follower.

2. A combined tamping tool and packing follower, according to claim 1, wherein a plurality of circumferentially spaced apertures are provided on the opposite end portion of the sleeve adapted to be engaged by a spanner wrench.

3. A combined tamping tool and packing follower, according to claim 1, wherein a plurality of circumferentially spaced drain holes extend radially through the sleeve side wall in proximity to the nose portion.

4. A combined tamping tool and packing follower, according to claim 3, wherein a radially inwardly extending seal is mounted on the interior surface of the sleeve in proximity to the drain holes.

5. A combined tamping tool and packing device, according to claim 1, wherein the sleeve comprises a pair of semi-circular halves and dowels connecting the semi-circular halves to form the cylindrical sleeve.
